(19) United States
(12) Patent Application Publication
(10) Pub. No.: US 2020/0175694 A1
(43) Pub. Date: Jun. 4, 2020

(54) INFORMATION PROCESSING DEVICE AND COMPUTER PROGRAM

(71) Applicant: Fujitsu Client Computing Limited, Kanagawa (JP)

(72) Inventor: Kei Kato, Kawasaki (JP)

(73) Assignee: Fujitsu Client Computing Limited, Kanagawa (JP)

(21) Appl. No.: 16/421,058

(22) Filed: May 23, 2019

(30) Foreign Application Priority Data
Nov. 30, 2018 (JP) 2018-225933

(51) Int. Cl. G06T 7/215; G06K 9/00; G06T 7/292; G06T 7/90

(52) U.S. Cl. CPC G06T 7/215; G06K 9/00771; G06T 2207/30242; G06T 7/90; G06T 7/292

(57) ABSTRACT

An information processing device includes a specification circuit and a count circuit. The specification circuit specifies, based on a similarity of speed depending on a change in positions of a plurality of movable objects in an image, two or more movable objects that correspond to a same real movable object in the movable objects. The count circuit counts the number of real movable objects that corresponds to the movable objects based on the specification result of the specification circuit.

### CROSS-REFERENCE TO RELATED APPLICATIONS

This application claims priority from Japanese Patent Application No. 2018-225933 filed on Nov. 30, 2018, the entire contents of which are incorporated herein by reference.

### FIELD

Embodiments described herein relate generally to an information processing device and a computer program.

### BACKGROUND

An information processing device includes an image analytical function, and detects movable objects such as persons and vehicles in an image using the image analytical function. In this case, the information processing device can also use this image analytical function for counting the number of movable objects from an image of a surveillance camera and the like.

### SUMMARY

However, when an image includes a movable object of a mirror image projected on a reflector such as a mirror, if the movable object of a mirror image and the movable object of a real image are each counted, the number of actual movable objects (real movable objects) in an image is unlikely to be correctly counted.

According to one aspect of the present disclosure, an information processing device includes a specification circuit and a count circuit. The specification circuit specifies, based on a similarity of speed depending on a change in positions of a plurality of movable objects in an image, two or more movable objects corresponding to a same real movable object in the movable objects. The count circuit counts the number of real movable objects corresponding to the movable objects based on the specification result of the specification circuit.

### BRIEF DESCRIPTION OF THE DRAWINGS

FIG. 1 is a view illustrating the schematic configuration of a system that includes an information processing device according to an embodiment of one example of the invention;

FIG. 2 is a view illustrating the hardware configuration of the information processing device according to the embodiment;

FIG. 3 is a view illustrating the functional configuration of the information processing device according to the embodiment;

FIGS. 4A and 4B are views illustrating a process for detecting movable objects (persons) according to the embodiment;

FIG. 5 is a view illustrating a process for detecting movement amounts of movable objects according to the embodiment;

FIGS. 6A and 6B are views illustrating calculated speed and acceleration according to the embodiment;

FIG. 7 is a view illustrating a process for detecting color components of movable objects according to the embodiment;

FIG. 8 is a view illustrating a process for detecting luminance components of movable objects according to the embodiment;

FIG. 9 is a view illustrating a process for detecting luminance components of movable objects according to the embodiment; and

FIG. 10 is a flowchart illustrating an operation of the information processing device according to the embodiment.

### DETAILED DESCRIPTION

Embodiments of an information processing device described in the present application will now be described with reference to the accompanying drawings. It should be noted that this embodiment is not intended to limit the scope of the invention. Like reference numerals indicate like components in the embodiment and overlapping explanation is omitted.

### Embodiments

An information processing device according to one or more embodiments includes an image analytical function, and detects movable objects such as persons and vehicles in an image using the image analytical function. In this case, the information processing device can also use this image analytical function for counting the number of movable objects from an image of a surveillance camera and the like.

However, if this method is used for counting the number of customers in a retail store and the like, when a person projected on a reflector such as a mirror and a window glass is taken by a surveillance camera at the same time, a mirror image may be counted as a person. For example, when five persons stand in front of a mirror, five persons of a real image and five persons of a mirror image, ten persons in total may be counted.

In a retail store, at the time of counting the number of store visitors for marketing research, if the number of store visitors is counted more than the actual number of persons, a deviation may be generated in sales data analysis, thereby affecting a calculation of profit and loss. Regarding the case described above, although the number of the movable objects can be correctly counted by using a plurality of cameras, but the number of the movable objects is unlikely to be correctly counted by using a single camera. It is desirable to correctly count the number of the movable objects by using a single camera in order to reduce costs of the information processing device.

In the present embodiment, the information processing device determines whether any movable object projected on a reflector such as a mirror and the like is present out of a plurality of movable objects included in an image, and counts the number of the movable objects in the image while excluding a duplicated movable object between a real image and a mirror image from to-be-counted objects in the image so as to achieve improvement in counting accuracy. The following describes a case where movable objects are persons, but movable objects as to-be-counted objects are not limited to persons and may be any other movable objects such as vehicles.

Specifically, the information processing device uses a function of detecting persons and a function of counting the number of persons existing in an image in the image analytical function. The information processing device measures time synchronization of movement of persons in an image, finds a pair of a real person (real object) and an image reflected on a mirror (mirror image) depending on the synchronization progress, and excludes one of the pairs from to-be-counted objects so as to improve accuracy of counting the number of persons.

In other words, the information processing device performs the following processing (1) and processing (2) or (3), depending on the result, excludes a duplicated movable object between a plurality of movable objects corresponds to the same real movable object from to-be-counted objects in an image, and counts the number of the real movable objects.

(1) A Comparison is Made of Time Synchronization for Changing Points of the Movement of Persons in an Image.

In the processing (1), an area of a person is specified using a known person detection technique. After several frames (at least one frame), the process for specification is performed in the same manner, and a movement amount is obtained from the difference. When this movement amount is accumulated, a time change of the movement amount of a specific person is obtained. In other words, time sampling of a time change is performed. When a plurality of persons are included in an image, the time change of this movement amount is compared. If the time change of the movement amount is closely similar, both may be identified as a relation of a pair of a real object and a mirror image. For example, a real object and a mirror image stop walking at the same timing, and start moving at the same timing. A comparison is made of the timing when figures stop movement and start movement, and person images having the similar timings may be identified as a pair of a real object and a mirror image. Alternatively, person images having a similar tendency of acceleration and deceleration (the other gently accelerates while one quickly accelerates, and the other gently decelerates while one quickly decelerates, and the like) may be identified as a pair of a real object and a mirror image. In this manner, a pair of a real object and a mirror image may be found from persons projected in an image (a pair is temporarily decided).

(2) Comparison of Color Components

A comparison is made of color components (containing color) of a target image identified as a relation of a pair in the processing (1). If person images are pertinent to the same person, close color components are detected, and this detection further supports the fact that the person images are a pair. For example, a person images divided into a plurality of parts and color component histograms are created. About a plurality of person images, color component histograms are compared for each part so as to obtain a coincidence degree of a profile. The coincidence degree is averaged about the parts of the person image. If the averaged coincidence degree exceeds a determination threshold, the color components are detected as color components similar to each other. If the averaged coincidence degree is less than a determination threshold, the color components are detected as color components dissimilar to each other. When the color components are detected as color components similar to each other, in other words, when close color components are detected, a candidate of a pair detected in the processing (1) is determined to be the pair.

(3) Comparison of Luminance Components

When color component greatly differs from each other (when color components are detected as dissimilar color components) in the processing (2), a comparison is also made of luminance. When a reflector is not a mirror but a window glass and the like, a width of luminance distribution of a mirror image is made smaller as compared with that of a real image. Specifically, a bright part such as white is reflected dark because a light amount is decreased.

For example, when a difference can be seen in a width of luminance distribution (machine learning and the like are used for presence/absence of a difference), a candidate of a pair detected in the processing (1) is determined to be the pair.

Alternatively, for example, when it is checked that there is a difference in width of a profile, a luminance histogram is created for each person image. About a plurality of person images, luminance histograms are compared in a range of a smaller width so as to obtain a coincidence degree of a profile. If the coincidence degree exceeds a determination threshold, the luminance components are detected as luminance components similar to each other. If the coincidence degree is less than a determination threshold, the luminance components are detected as luminance components dissimilar to each other. In other words, if close color components are detected when there is a difference in width of a profile and a comparison is made in a range of a smaller width, both are defined as having a relation of the pair. In this case, a candidate of a pair detected in the processing (1) is determined to be the pair.

The relation among (1), (2), and (3) is ‘(1) AND ((2) OR (3))’. In the processing (1), persons performing the same movement are extracted. Only this processing causes persons walking side by side to be defined as the same person. By determination of (2) (assuming a normal mirror) or determination of (3) (reflector and the like such as a window glass at night), it is determined whether adjacent persons are the same person or different persons.

The processing (1) to (3) enables synchronization of movement of a person in a photographed image to be easily detected, thereby easily finding a pair of a mirror image and a real image. Thus, one of the pair may be identified as a to-be-counted person, and the more correct number of persons may be counted. In addition, by combining determination of color components and luminance components, determination of a real image and a mirror image may be made more correctly. In this manner, counting the correct number of persons may be implemented, and accuracy may be improved when data analysis such as statistics is performed.

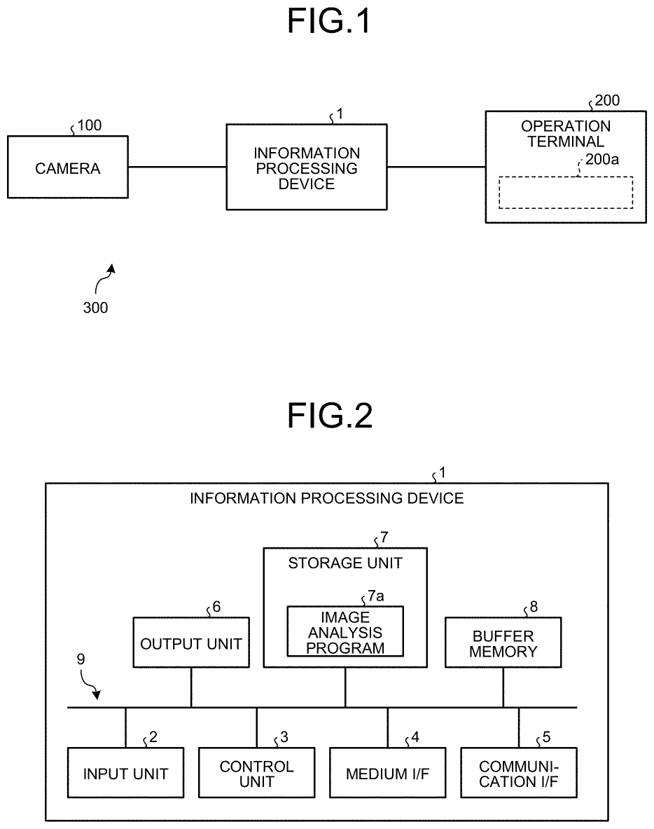

More specifically, a system 300 that includes an information processing device 1 may be formed as illustrated in FIG. 1. FIG. 1 is a view illustrating the configuration of the system 300 that includes the information processing device 1.

The system 300 includes a camera 100, the information processing device 1, and an operation terminal 200. The camera 100, the information processing device 1, and the operation terminal 200 are communicatively connected to each other through a network (for example, a wireless local area network (LAN) and/or a wired LAN). The camera 100 may be, for example, a surveillance camera installed in a target space for counting a movable object (for example, a person). The information processing device 1 is, for example, a computer, and receives an image of a target space imaged by the camera 100, performs image analysis along with an image analytical function, counts the number of movable objects in the target space, and outputs a count result to the operation terminal 200. The operation terminal 200 includes a display screen 200a, and can display a count result of the number of movable objects on the display screen 200a. Thus, a user of the operation terminal 200 may recognize a count result of the number of movable objects.

As illustrated in FIG. 2, the information processing device 1 can be formed in a hardware manner. FIG. 2 is a view illustrating the hardware configuration of the information processing device 1.

The information processing device 1 includes an input unit 2, a control unit 3, a medium interface (I/F) 4, a communication I/F 5, an output unit 6, a storage unit 7, a buffer memory 8, and a bus 9. The input unit 2, the control unit 3, the medium I/F 4, the communication I/F 5, the output unit 6, the storage unit 7, and the buffer memory 8 are communicatively connected to each other through the bus 9.

The input unit 2 may receive information. Examples of the input unit 2 may include a keyboard and a mouse. The control unit 3 integrally controls the information processing device 1. The control unit 3 may be, for example, a hardware processor such as a central processing unit (CPU). The medium I/F 4 may read and write information on a recording medium. The communication I/F 5 may communicate with the camera 100 and the operation terminal 200 through a network (for example, a wireless LAN and/or a wired LAN). The output unit 6 may output information. Examples of the output unit 6 may include a display and a speaker. The storage unit 7 may store therein information. Examples of the storage unit 7 may include a read only memory (ROM) and a hard disk drive (HDD). The storage unit 7 may store therein an image analysis program 7a. The image analysis program 7a may be a program for controlling each process of an image analytical function. The buffer memory 8 may temporarily store information, and may be used as a work area by the control unit 3. The buffer memory 8 may be, for example, a random access memory (RAM).

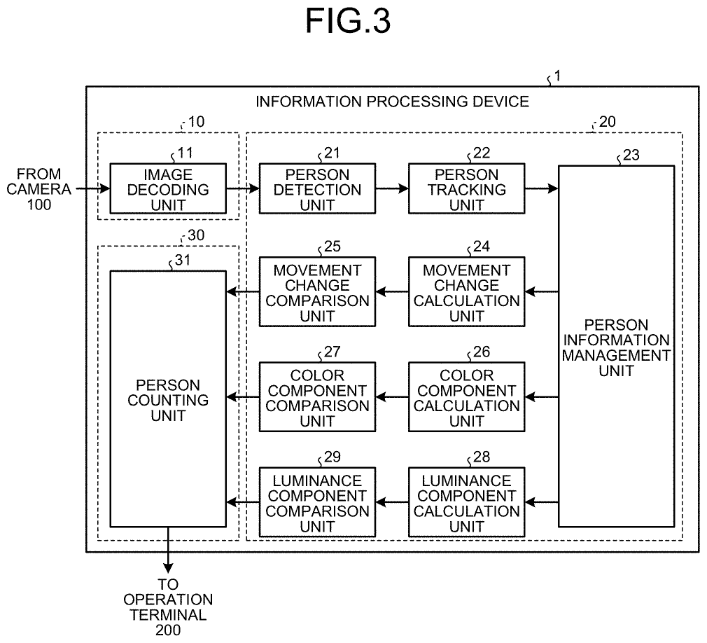

For example, in the information processing device 1, the control unit 3 reads the image analysis program 7a from the storage unit 7, and expands, when compliling, each function module depending on the image analysis program 7a on the buffer memory 8 collectively or sequentially in response to progress of processing. In this manner, the image analysis program 7a functionally enables the configuration illustrated in FIG. 3 to be implemented in the information processing device 1. In other words, the information processing device 1 may be formed functionally as illustrated in FIG. 3. FIG. 3 is a view illustrating the functional configuration of the information processing device 1.

The information processing device 1 may include an acquisition circuit 10, a specification circuit 20, and a count circuit 30. The acquisition circuit 10 acquires an image of a target space from the camera 100. The acquisition circuit 10 includes an image decoding unit 11. The image decoding unit 11 decodes image data input from the camera 100 in a predetermined format, and expands the image data into image information that can be recognized by the specification circuit 20. The acquisition circuit 10 supplies an image of a target space (image information) to the specification circuit 20.

The specification circuit 20 detects a plurality of movable objects from an image of a target space, obtains a change in positions of the movable objects, and obtains similarity of speed depending on the change in positions. The specification circuit 20 specifies, based on the similarity of speed of movable objects, two or more movable objects corresponding to the same real movable object in the movable objects. For example, the specification circuit 20 specifies, based on the similarity of a timing when speed of a movable object starts changing or a timing when speed of a movable object stops changing, two or more movable objects corresponding to the same real movable object in the movable objects. Alternatively, the specification circuit 20 specifies, based on the similarity of tendency of a change in speed of movable objects, two or more movable objects corresponding to the same real movable object in the movable objects. Alternatively, the specification circuit 20 specifies, based on the similarity of speed of movable objects in an image and the similarity of color components or the similarity of luminance components of the movable objects, two or more movable objects corresponding to the same real movable object in the movable objects. Alternatively, the specification circuit 20 distinguishes, based on the distribution of luminance components of movable objects, a movable object as a real image from a movable object as a mirror image out of the two or more specified movable objects.

The specification circuit 20 includes a person detection unit 21, a person tracking unit 22, a person information management unit 23, a movement change calculation unit 24, a movement change comparison unit 25, a color component calculation unit 26, a color component comparison unit 27, a luminance component calculation unit 28, and a luminance component comparison unit 29.

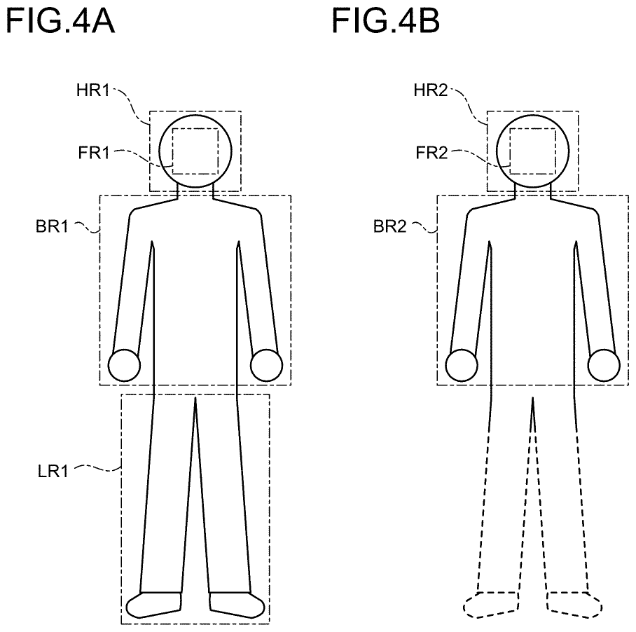

The person detection unit 21 detects an image of a person from an image of a target space. As illustrated in FIG. 4, the person detection unit 21 may detect an image of a person from an image of a target space. FIG. 4 is a view illustrating the process for detecting movable objects (persons).

For example, as illustrated in FIG. 4A, the person detection unit 21 detects a face region FR1 corresponding to a face of a person from an image by searching a region having a high coincidence degree with a template image of a preliminarily registered face region. The person detection unit 21 performs outline extraction such as edge detection about a region including the detected face region FR1, and searches a region having a high coincidence degree with an outline image of a preliminarily registered head so as to detect a head region HR1 corresponding to a head of a person. The person detection unit 21 performs outline extraction such as edge detection about a region including the head region HR1, and searches a region having a high coincidence degree with an outline image of a preliminarily body and having a length in the longitudinal direction approximately three times greater than that of the head region HR1 so as to detect a body region BR1 corresponding to a body of a person. The person detection unit 21 performs outline extraction such as edge detection about a region including the body region BR1, and searches a region having a high coincidence degree with an outline image of a preliminarily registered lower body and the remaining region in the outline so as to detect a lower body region LR1 corresponding to a lower body of a person. Based on the detection, the person detection unit 21 obtains a coordinate position of a person in an image as coordinate information. The person detection unit 21 supplies information on an image of a person including information on the face region FR1, the head region HR1, the body region BR1, and the lower body region LR1, and coordinate information as a detection result to the person tracking unit 22.

Alternatively, for example, as illustrated in FIG. 4B, the person detection unit 21 may detect an image of a person a part of the lower body of which is missing. In other words, similarly to FIG. 4A, the person detection unit 21 sequentially detects a face region FR2, a head region HR2, and a body region BR2, and determines, when not detecting a lower body region, that the image is an image of a person a part of the lower body of which is missing. Based on the detection, the person detection unit 21 obtains a coordinate position of a person in an image as coordinate information. The person detection unit 21 supplies information on an image of a person including information on the face region FR2, the head region HR2, and the body region BR2, and coordinate information as a detection result to the person tracking unit 22.

The person tracking unit 22 assigns an identification (local identification (ID)) to a person detected by the person detection unit 21, and tracks the same person after a succeeding frame. For example, the person tracking unit 22 performs matching processing with a person image of the last frame image for each local ID, and associates a person image having the maximum matching score as the same person with the local ID and tracks the person image.

The person information management unit 23 holds person management information that associates a local ID assigned by the person tracking unit 22 with image information on a person and coordinate information detected by the person detection unit 21 in time series. The person information management unit 23 successively supplies person management information to the movement change calculation unit 24, the color component calculation unit 26, and the luminance component calculation unit 28.

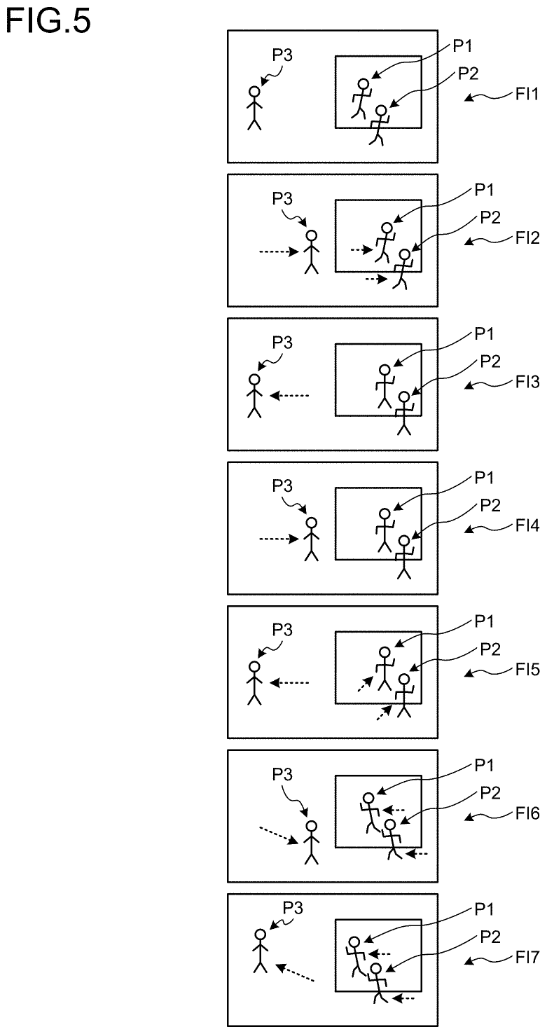

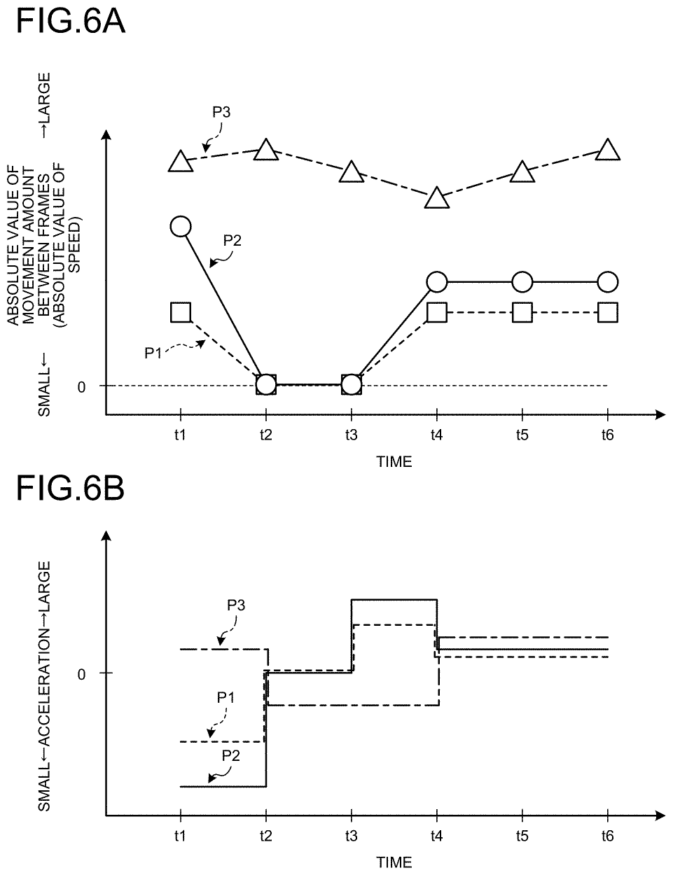

The movement change calculation unit 24 calculates information related to a change in movement time of a person in the same image (movement change information) based on time-series coordinate information of a person in the person information management unit 23. As illustrated in FIGS. 5 and 6, the movement change calculation unit 24 may calculate a change in movement time of a person in an image. FIG. 5 is a view illustrating the process for detecting movement amounts of movable objects. FIG. 5 illustrates frame images FI1 to FI7 that mutually continue in time, and illustrates persons with persons drawn by a line for simplification of the drawing. FIG. 5 illustrates a case where local IDs of the respective persons are P1 to P3. FIG. 6A is a view illustrating absolute values of calculated movement amounts (≈‘absolute values of speed’), and a vertical axis and a horizontal axis indicate an absolute value of a movement amount between frames and time, respectively. FIG. 6B is a view illustrating calculated acceleration, and a vertical axis and a horizontal axis indicate acceleration and time, respectively.

The movement change calculation unit 24 compares the frame image FI1 with the frame image FI2. The movement change calculation unit 24 obtains, about each of the persons P1 to P3, a motion vector as illustrated in the dotted line in the frame image FI2 from a change in coordinate position, and plots a length of the motion vector as an absolute value of a movement amount at a position corresponding to a time t1 in the graph illustrated in FIG. 6A.

The movement change calculation unit 24 compares the frame image FI2 with the frame image FI3. The movement change calculation unit 24 obtains, about each of the persons P1 to P3, a motion vector as illustrated in the dotted line in the frame image FI3 from a change in coordinate position, and plots a length of the motion vector as an absolute value of a movement amount at a position corresponding to a time t2 in the graph illustrated in FIG. 6A.

The movement change calculation unit 24 compares the frame image FI3 with the frame image FI4. The movement change calculation unit 24 obtains, about each of the persons P1 to P3, a motion vector as illustrated in the dotted line in the frame image FI4 from a change in coordinate position, and plots a length of the motion vector as an absolute value of a movement amount at a position corresponding to a time t3 in the graph illustrated in FIG. 6A.

The movement change calculation unit 24 compares the frame image FI4 with the frame image FI5. The movement change calculation unit 24 obtains, about each of the persons P1 to P3, a motion vector as illustrated in the dotted line in the frame image FI5 from a change in coordinate position, and plots a length of the motion vector as an absolute value of a movement amount at a position corresponding to a time t4 in the graph illustrated in FIG. 6A.

The movement change calculation unit 24 compares the frame image FI5 with the frame image FI6. The movement change calculation unit 24 obtains, about each of the persons P1 to P3, a motion vector as illustrated in the dotted line in the frame image FI6 from a change in coordinate position, and plots a length of the motion vector as an absolute value of a movement amount at a position corresponding to a time t5 in the graph illustrated in FIG. 6A.

The movement change calculation unit 24 compares the frame image FI6 with the frame image FI7. The movement change calculation unit 24 obtains, about each of the persons P1 to P3, a motion vector as illustrated in the dotted line in the frame image FI7 from a change in coordinate position, and plots a length of the motion vector as an absolute value of a movement amount at a position corresponding to a time t6 in the graph illustrated in FIG. 6A.

In this manner, a temporal change of an absolute value of a movement amount for each of the persons P1 to P3 illustrated in FIG. 6A is obtained. A temporal change of an absolute value of a movement amount for each of the persons P1 to P3 represents approximately a temporal change of an absolute value of speed for each of the persons P1 to P3. In FIG. 6A, a temporal change of an absolute value of a movement amount (≈‘absolute value of speed’) for the person P1 is illustrated by a dotted line, a temporal change of an absolute value of a movement amount (≈‘absolute value of speed’) for the person P2 is illustrated by a solid line, and a temporal change of an absolute value of a movement amount (≈‘absolute value of speed’) for the person P3 is illustrated by a dot-and-dash line.

The movement change calculation unit 24 approximates a change between plots in the graph illustrated in FIG. 6A by a straight line, and approximately obtains acceleration of each of the persons P1 to P3 illustrated in FIG. 6B from an inclination of the straight line. In FIG. 6B, a temporal change of an absolute value of acceleration for the person P1 is illustrated by a dotted line, a temporal change of an absolute value of acceleration for the person P2 is illustrated by a solid line, and a temporal change of an absolute value of acceleration for the person P3 is illustrated by a dot-and-dash line.

The movement change calculation unit 24 supplies calculated movement change information (for example, information on a temporal change of an absolute value of speed illustrated in FIG. 6A and/or information on a temporal change of acceleration illustrated in FIG. 6B) to the movement change comparison unit 25.

The movement change comparison unit 25 makes a comparison of a change in movement time of each person calculated by the movement change calculation unit 24 in a round-robin for the number of persons. In other words, the movement change comparison unit 25 specifies, out of a plurality of movable objects detected in an image (for example, the persons P1 to P3 illustrated in FIG. 5), two or more movable objects corresponding to the same real movable object based on the movement change information.

For example, the movement change comparison unit 25 refers to a temporal change of an absolute value of speed illustrated in FIG. 6A, and determines that the persons P1 and P2 are the same person because the timing when speed of the persons P1 and P2 decreases and becomes 0 is coincident at the time t2 and the timing when speed of the persons P1 and P2 increases from 0 is coincident at the time t3. By contrast, the movement change comparison unit 25 determines that the same person does not exist for the person P3 because there is no one that has a timing coincident with a timing when speed of the person P3 stops changing and that has a timing coincident with a timing when speed of the person P3 starts changing.

Alternatively, for example, the movement change comparison unit 25 refers to a temporal change of acceleration illustrated in FIG. 6B, and determines that the persons P1 and P2 are the same person because the period when acceleration of the persons P1 and P2 is negative is coincident and the period when acceleration of the persons P1 and P2 is positive is coincident. By contrast, the movement change comparison unit 25 determines that the same person does not exist for the person P3 because there is no one that has a period coincident with a period when acceleration of the person P3 is negative and that has a period coincident with a period when acceleration of the person P3 is positive.

The movement change comparison unit 25 supplies a comparison result of a change in movement time for each person (in other words, a result of specifying, out of a plurality of movable objects, two or more movable objects corresponding to the same real movable object) to the count circuit 30.

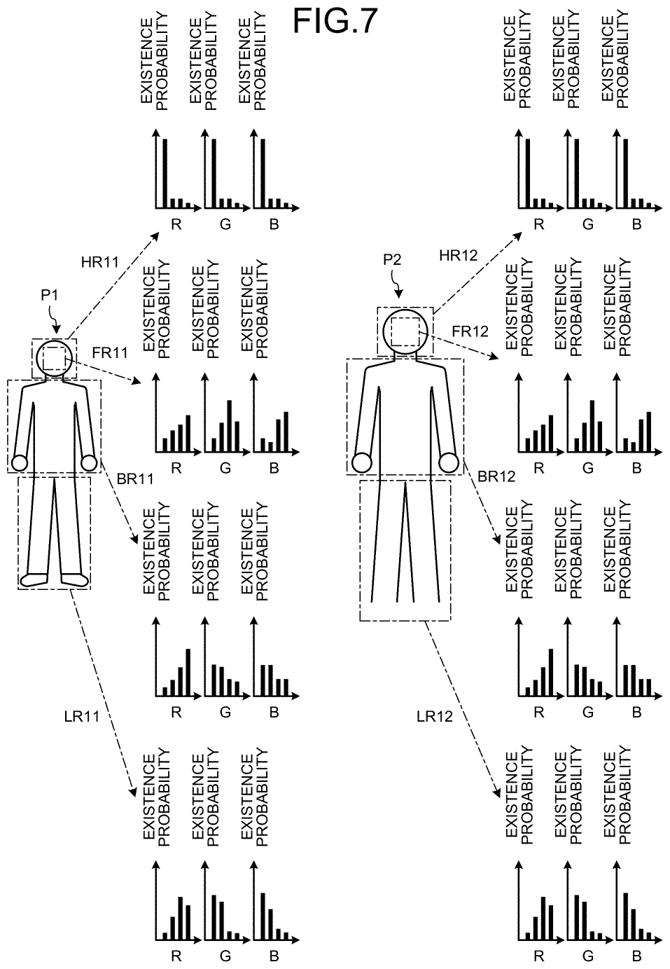

The color component calculation unit 26 extracts color information included in a person detected by the person detection unit 21. The color component calculation unit 26 creates a color component histogram with respect to a person holding a local ID. As illustrated in FIG. 7, the color component calculation unit 26 may create color component histograms for a plurality of parts in a person in order to extract characteristics. FIG. 7 illustrates color component histograms created about head regions HR11 and HR 12 (except for face regions FR11 and FR12), the face regions FR11 and FR12, body regions BR11 and BR12, and lower body regions LR11 and LR12 of the persons P1 and P2, respectively.

For example, the color component calculation unit 26 counts, in an image of the head region HR11 of the person P1, the number of pixels about color components of red (R), green (G), and blue B for each signal level, and plots the distribution as a histogram. The color component calculation unit 26 divides the vertical axis by the total number of pixels and converts the number of pixels into an existence probability of color components so as to display the converted existence probability of color components, converts the horizontal axis into a gradation value of color components (color density) where a signal level in between maximum and minimum is divided into a predetermined number (for example, 256) so as to display the converted gradation value, and obtains a color component histogram of the head region HR11 of the person P1 as illustrated in FIG. 7. The color component calculation unit 26 obtains color component histograms in an image of the face region FR11 of the person P1, an image of the body region BR11 of the person P1, and an image of the lower body region LR11 of the person P1 in the same manner.

The color component calculation unit 26 counts, in an image of the head region HR12 of the person P2, the number of pixels about color components of red (R), green (G), and blue B for each signal level, and plots the distribution as a histogram. The color component calculation unit 26 divides the vertical axis by the total number of pixels and converts the number of pixels into an existence probability of color components so as to display the converted existence probability of color components, converts the horizontal axis into a gradation value of color components (color density) where a signal level in between maximum and minimum is divided into a predetermined number (for example, 256) so as to display the converted gradation value, and obtains a color component histogram of the head region HR12 of the person P2 as illustrated in FIG. 7. The color component calculation unit 26 obtains color component histograms in an image of the face region FR12 of the person P2, an image of the body region BR12 of the person P2, and an image of the lower body region LR12 of the person P2 in the same manner.

About the other person in an image (for example, the person P3 illustrated in FIG. 5), the color component calculation unit 26 can also obtain color component histograms for each part of the person in the same manner, which is not illustrated. In addition, the color component calculation unit 26 can extract color with less noise by deleting a person background using a difference with an image where no person exists.

The color component calculation unit 26 supplies a color component histogram for each part of each person to the color component comparison unit 27.

The color component comparison unit 27 compares, about a plurality of person images that are defined as candidates of a pair by the movement change comparison unit 25, color component histograms for each part and obtains a coincidence degree of a profile.

For example, the color component comparison unit 27 may obtain, using OpenCV that is an open source software library of an image processing system, comparison among the color component histograms obtained by the color component calculation unit 26 from the Bhattacharyya distance and the chi-square distribution. When the Bhattacharyya distances of red (R), green (G), and blue B are defined as S_{R}, S_{G}, and S_{B}, respectively, the coincidence degree (similarity) S can be calculated by the following expression 1.

S=√/(S_{R}²+S_{G}²+S_{B}²) Expression 1

The color component comparison unit 27 averages the coincidence degree S about a plurality of parts of a figure. If the averaged coincidence degree S_{AV} exceeds a determination threshold Sₜₕ, the color components are detected as color components similar to each other. If the averaged coincidence degree S_{AV} is less than a determination threshold Sₜₕ, the color components are detected as color components dissimilar to each other. When the color components are detected as color components similar to each other, in other words, when close color components are detected, two compared persons are determined to be images (real image, mirror image) corresponding the same person.

The color component comparison unit 27 supplies a comparison result of color components of each person (in other words, a result of specifying two or more movable objects corresponding to the same real movable object in the movable objects) to the count circuit 30.

The luminance component calculation unit 28 converts red-green-blue (RGB) components of a person image detected by the person detection unit 21 into YUV components, and extracts luminance information (Y) as a histogram from the YUV components. The luminance component calculation unit 28 obtains, with respect to a person holding a local ID, RGB components of the whole person, performs YUV conversion on the obtained RGB components, and extracts luminance components (Y) from the converted YUV components. The luminance component calculation unit 28 may implement extraction of luminance components (Y) as gray scale conversion with respect to a color image of a person.

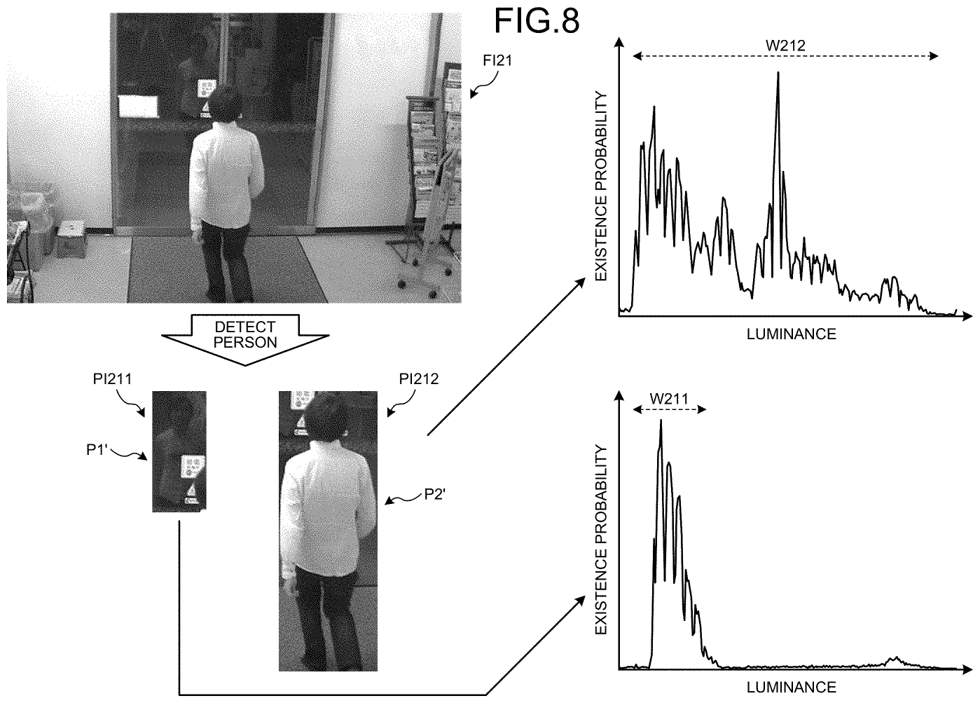

For example, as illustrated in FIG. 8, the luminance component calculation unit 28 creates, about persons P1′ and P2′ in a frame image FI21 (that includes, for example, a bright part such as white), gray scale images of person regions PI211 and PI212. The luminance component calculation unit 28 counts, about each of the gray scale images of the person regions PI211 and PI212, the number of pixels for each luminance level, and plots the distribution as a histogram. The luminance component calculation unit 28 divides the vertical axis by the total number of pixels and converts the number of pixels into an existence probability of luminance components so as to display the converted existence probability of luminance components, converts the horizontal axis into a gradation value of luminance components where a luminance level in between maximum and minimum is divided into a predetermined number (for example, 256) so as to display the converted gradation value, and obtains luminance component histograms of the persons P1′ and P2′ as illustrated in FIG. 8.

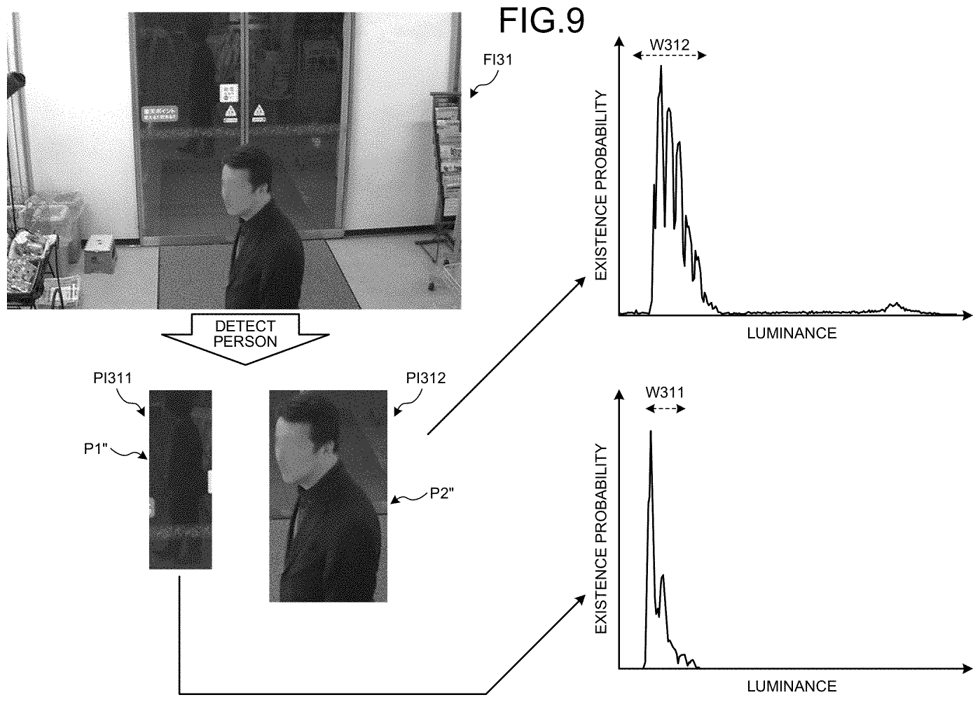

For example, as illustrated in FIG. 9, the luminance component calculation unit 28 creates, about persons P1″ and P2″ in a frame image FI31 (that includes, for example, a dark part such as black), gray scale images of person regions PI311 and PI312. The luminance component calculation unit 28 counts, about each of the gray scale images of the person regions PI311 and PI312, the number of pixels for each luminance level, and plots the distribution as a histogram. The luminance component calculation unit 28 divides the vertical axis by the total number of pixels and converts the number of pixels into an existence probability of luminance components so as to display the converted existence probability of luminance components, converts the horizontal axis into a gradation value of luminance components where a luminance level in between maximum and minimum is divided into a predetermined number (for example, 256) so as to display the converted gradation value, and obtains luminance component histograms of the persons P1″ and P2″ as illustrated in FIG. 9.

The luminance component calculation unit 28 supplies a luminance component histogram for each person to the luminance component comparison unit 29.

The luminance component comparison unit 29 obtains, about each of the person images that are identified as candidates of a pair by the movement change comparison unit 25, but have significantly different color components in a comparison result of the color component comparison unit 27, a spectrum width of a luminance component histogram.

For example, as illustrated in FIG. 8, the luminance component comparison unit 29 obtains, about the persons P1′ and P2′, spectrum widths of luminance component histograms as W211 and W212, respectively, and compares the spectrum width W211 of the person P1′ with the spectrum width W212 of the person P2′. If the larger spectrum width W212 is equal to or greater than a threshold magnification (for example, 1.5 times) with respect to the smaller spectrum width W211, the luminance component comparison unit 29 may determine that the person P1′ corresponding to the smaller spectrum width is a mirror image.

For example, as illustrated in FIG. 9, the luminance component comparison unit 29 obtains, about the persons P1″ and P2″, spectrum widths of luminance component histograms as W311 and W312, respectively, and compares the spectrum width W311 of the person P1″ with the spectrum width W312 of the person P2″. If the larger spectrum width W312 is equal to or greater than a threshold magnification (for example, 1.5 times) with respect to the smaller spectrum width W311, the luminance component comparison unit 29 may determine that the person P1″ corresponding to the smaller spectrum width is a mirror image.

The luminance component comparison unit 29 illustrated in FIG. 3 may make a comparison using spreading dispersion (or standard deviation) of components of a spectrum in place of a spectrum width of a luminance component histogram.

Alternatively, the luminance component comparison unit 29 makes a comparison of luminance components obtained by the luminance component calculation unit 28 about a plurality of person images identified as candidates of a pair by the movement change comparison unit 25. About the person images, the luminance component comparison unit 29 compares luminance component histograms in a range of a smaller width so as to obtain a coincidence degree of a profile. If the coincidence degree exceeds a determination threshold, the luminance components are detected as luminance components similar to each other. If the coincidence degree is less than a determination threshold, the luminance components are detected as luminance components dissimilar to each other. In other words, if close luminance components are detected when there is a difference in width of a profile and a comparison is made in a range of a smaller width, both person images are identified as a relation of a pair. In this case, candidates of a pair detected in the processing (1) are determined to be the pair.

The luminance component comparison unit 29 supplies a comparison result of luminance components of each person (in other words, a result of specifying two or more movable objects corresponding the same real movable object in the movable objects) to the count circuit 30.

The count circuit 30 counts the number of real movable objects corresponding to movable objects based on a specification result of the specification circuit 20. In other words, the count circuit 30 excludes, out of the two or more movable objects specified as the movable objects corresponding to the same real movable object, a duplicated movable object from to-be-counted objects, and counts the number of the real movable objects corresponding to the movable objects. Alternatively, when the specification circuit 20 distinguishes a movable object as a real image with a movable object as a mirror image, the count circuit 30 excludes, out of the two or more specified movable objects, a movable object as a mirror image from to-be-counted objects, and counts the number of the real movable objects corresponding to the movable objects.

The count circuit 30 includes a person counting unit 31. When a comparison result of the movement change comparison unit 25 is identified as CR1, a comparison result of the color component comparison unit 27 is identified as CR2, and a comparison result of the luminance component comparison unit 29 is identified as CR3, the person counting unit 31 calculates (CR1)AND{(CR2)OR(CR3)} so as to assign a global ID to each person with removing duplicated persons. In other words, the person counting unit 31 assigns common global IDs to persons identified as a pair of the same person, and assigns different global IDs to persons identified as a different person. The person counting unit 31 counts the number of issued global IDs so as to count persons in an image with removing duplicated persons.

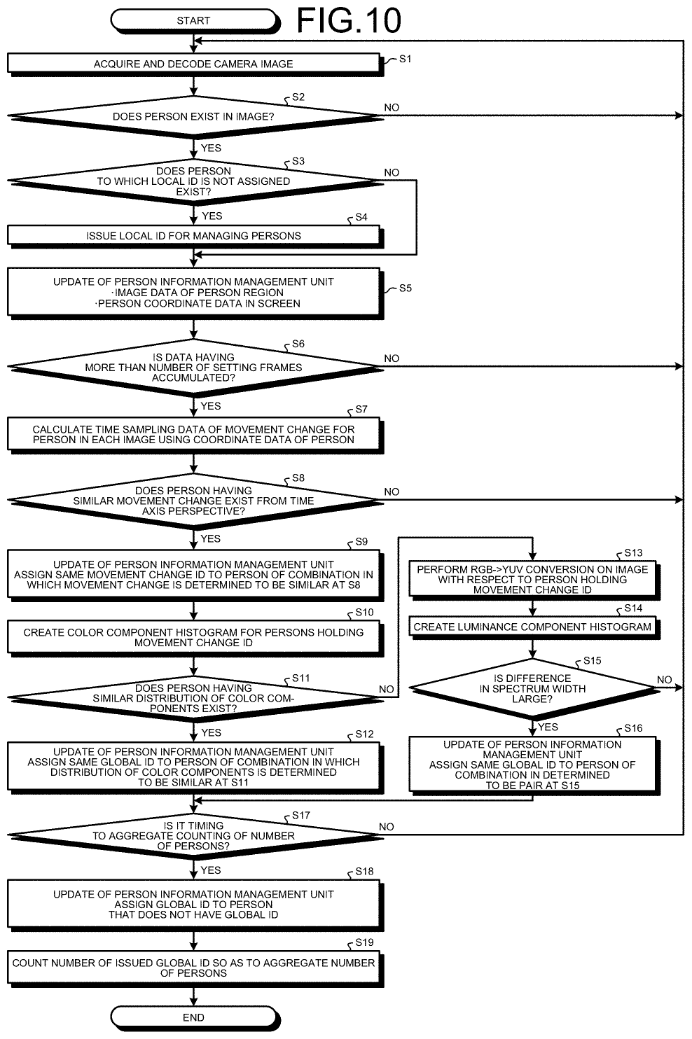

The following describes operation of the information processing device 1 with reference to FIG. 10. FIG. 10 is a flowchart illustrating operation of the information processing device 1.

The acquisition circuit 10 in the information processing device 1 acquires and decodes a camera image (S1), and supplies a decode result to the specification circuit 20. The specification circuit 20 determines whether a person exists in an image (S2). If not (No at S2), the process goes back to S1, and if a person exists in an image (Yes at S2), the specification circuit 20 determines whether a person to which a local ID for managing persons is not assigned exists in an image (S3). If not (No at S3), the process skips S4 and goes to S5, and if a person to which a local ID is not assigned exists in an image (Yes at S3), the specification circuit 20 issues and assigns a local ID to the person to which a local ID is not assigned (S4).

Depending on results of S4, the specification circuit 20 updates information managed by the person information management unit 23 (S5). In other words, the specification circuit 20 adds image data of a person region of a person to which a local ID is assigned and person coordinate data in a screen to information managed by the person information management unit 23 and updates the information.

The specification circuit 20 determines whether data having more than the number of setting frames is accumulated (S6). If the number of pieces of accumulated data is less than the number of setting frames (No at S6), the process goes back to S1. If the number of pieces of accumulated data is equal to or greater than the number of setting frames (Yes at S6), the specification circuit 20 calculates time sampling data of a movement change for a person in each image using coordinate data of the person (S7).

The specification circuit 20 determines whether a person having a similar movement change exists from a time axis perspective (S8). If not (No at S8), the process goes back to S1. If a person having a similar movement change exists (Yes at S8), the specification circuit 20 updates information managed by the person information management unit 23 (S9). In other words, the specification circuit 20 assigns the same movement change ID to the person of a combination in which a movement change is determined to be similar at S8 and updates the information managed by the person information management unit 23.

The specification circuit 20 creates color component histograms for a plurality of persons holding the same movement change ID (S10), and determines whether a person having a similar distribution of color components exists (S11).

If a person having a similar distribution of color components exists (Yes at S11), the specification circuit 20 updates information managed by the person information management unit 23 (S12). In other words, the specification circuit 20 assigns the same global ID to the person of a combination in which distribution of color components is determined to be similar at S11 and updates the information managed by the person information management unit 23.

If a person having a similar distribution of color components does not exist (No at S11), the specification circuit 20 performs RGB->YUV conversion on an image with respect to a person holding a movement change ID (S13). The specification circuit 20 extracts luminance components (Y components) from an image after YUV conversion, and creates a luminance component histogram (S14). The specification circuit 20 refers to a profile of a luminance component histogram, and determines whether a difference in spectrum width is large (S15). The specification circuit 20 compares luminance component histograms of a plurality of persons. If a larger spectrum width is equal to or greater than a threshold magnification (for example, 1.5 times) with respect to a smaller spectrum width, the specification circuit 20 may determine that a difference in spectrum width is large and both are a pair, and if a larger spectrum width is less than a threshold magnification (for example, 1.5 times) with respect to a smaller spectrum width, the specification circuit 20 may determine that a difference in spectrum width is not large and both are not in the relation of a pair.

If a difference in spectrum width is not large (No at S15), the process goes back to S1. If a difference in spectrum width is large (Yes at S15), the specification circuit 20 supplies a specification result of the specification circuit 20 to the count circuit 30. The count circuit 30 updates information managed by the person information management unit 23 based on the specification result of the specification circuit 20 (S16). In other words, the count circuit 30 assigns the same global ID to the person of a combination determined to be a pair at S15, and updates the information managed by the person information management unit 23.

The count circuit 30 determines whether it is a timing to aggregate counting of the number of persons (S17). If not (No at S17), the process goes back to S1.

If it is a timing to aggregate counting of the number of persons (Yes at S17), the count circuit 30 updates the information managed by the person information management unit 23 (S18). In other words, the count circuit 30 assigns a global ID to the person to which the global ID is not assigned and updates the information managed by the person information management unit 23.

The count circuit 30 counts the number of issued global IDs so as to aggregate the number of persons (S19).

As described above, in the embodiment, the information processing device 1 determines whether a movable object projected on a reflector such as a mirror is present out of a plurality of movable objects included in an image, and counts the number of movable objects while excluding a duplicated movable object between a real image and a mirror image from to-be-counted objects in the image. In this manner, counting accuracy of movable objects in the image can be improved.

In the embodiment, in the information processing device 1, the specification circuit 20 specifies, based on, for example, the similarity of a timing when speed of a movable object starts changing or a timing when speed of a movable object stops changing, two or more movable objects corresponding to the same real movable object in a plurality of movable objects. In this manner, two or more movable objects corresponding to the same real movable object can be specified accurately.

In the embodiment, in the information processing device 1, the specification circuit 20 specifies, based on, for example, the similarity of tendency of a change in speed of movable objects, two or more movable objects corresponding to the same real movable object in the movable objects. In this manner, two or more movable objects corresponding to the same real movable object can be specified accurately.

In the embodiment, in the information processing device 1, the specification circuit 20 specifies, based on, for example, the similarity of speed of movable objects in an image and the similarity of color components or the similarity of luminance components of the movable objects, two or more movable objects corresponding to the same real movable object in the movable objects. In this manner, two or more movable objects corresponding to the same real movable object can be specified accurately.

In the embodiment, in the information processing device 1, the specification circuit 20 distinguishes, based on the distribution of luminance components of movable objects, a movable object as a real image from a movable object as a mirror image out of the two or more specified movable objects. In this manner, a movable object as a real image and a movable object as a mirror image corresponding to the same real movable object can be specified accurately.

In the embodiment, in the information processing device 1, the count circuit 30 excludes, out of the two or more specified movable objects, a duplicated movable object from to-be-counted objects, and counts the number of real movable objects corresponding to the movable objects. In this manner, the number of real movable objects out of the movable objects included in an image can be counted accurately.

In the embodiment, in the information processing device 1, the specification circuit 20 distinguishes, based on the distribution of luminance components of movable objects, a movable object as a real image from a movable object as a mirror image out of the two or more specified movable objects. The count circuit 30 excludes, out of the two or more specified movable objects, a movable object as a mirror image from to-be-counted objects, and counts the number of real movable objects corresponding to the movable objects. In this manner, the number of real movable objects out of the movable objects reflected in an image can be counted accurately.

In the embodiment, in the information processing device 1, the image analysis program 7a causes the information processing device 1 to function as the specification circuit 20 and the count circuit 30. The specification circuit 20 specifies, based on the similarity of speed depending on a change in positions of movable objects in an image, two or more movable objects corresponding to the same real movable object in the movable objects. The count circuit 30 counts the number of real movable objects corresponding to the movable objects based on the specification result of the specification circuit 20. In this manner, counting accuracy of movable objects can be improved.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
a specification circuit that specifies, based on a similarity of speed depending on a change in positions of a plurality of movable objects in an image, two or more movable objects that correspond to a same real movable object in the movable objects; and
a count circuit that counts a number of real movable objects that corresponds to the movable objects based on specification result of the specification circuit.

2. The information processing device according to claim 1, wherein
the specification circuit specifies, based on a similarity of a timing when speed of the movable object starts changing or a timing when speed of the movable object stops changing, two or more movable objects that correspond to the same real movable object in the movable objects.

3. The information processing device according to claim 1, wherein
the specification circuit specifies, based on a similarity of tendency of a change in speed of the movable object, two or more movable objects that correspond to the same real movable object in the movable objects.

4. The information processing device according to claim 1, wherein
the specification circuit specifies, based on the similarity of speed of the movable objects in the image and a similarity of color components or a similarity of luminance components of the movable objects, two or more movable objects that correspond to the same real movable object in the movable objects.

5. The information processing device according to claim 4, wherein
the specification circuit distinguishes, based on a distribution of luminance components of the movable objects, a movable object as a real image from a movable object as a mirror image out of the two or more specified movable objects.

6. The information processing device according to claim 1, wherein
the count circuit excludes, out of the two or more specified movable objects, a duplicated movable object from to-be-counted objects, and counts the number of real movable objects that corresponds to the movable objects.

7. The information processing device according to claim 4, wherein
the specification circuit distinguishes, based on a distribution of luminance components of the movable objects, a movable object as a real image from a movable object as a mirror image out of the two or more specified movable objects, and
the count circuit excludes, out of the two or more specified movable objects, a movable object as the mirror image from to-be-counted objects, and counts the number of real movable objects that corresponds to the movable objects.

8. A non-transitory computer-readable storage medium having a computer program stored therein, the computer program causing a computer to perform:
specifying, based on a similarity of speed depending on a change in positions of a plurality of movable objects in an image, two or more movable objects that correspond to a same real movable object in the movable objects; and
counting a number of real movable objects that corresponds to the movable objects based on a result of the specification.
